(19) United States
(12) Patent Application Publication
(10) Pub. No.: US 2015/0190709 A1
(43) Pub. Date: Jul. 9, 2015

(54) SYSTEMS AND METHODS FOR GAMIFICATION OF A PROBLEM

(71) Applicant: Ganalila, LLC, Boston, MA (US)

(72) Inventors: Jaisree Moorthy, Boston, MA (US); Shreedhar Natarajan, Boston, MA (US)

(21) Appl. No.: 14/419,046

(22) PCT Filed: Aug. 1, 2013
(86) PCT No.: PCT/US13/53230

§ 371 Date: Feb. 2, 2015

Related U.S. Application Data
(60) Provisional application No. 61/678,739, filed on Aug. 2, 2012.

(51) Int. Cl. A63F 9/18; G09B 19/00

(52) U.S. Cl. CPC A63F 9/183; G09B 19/00

(57) ABSTRACT

Methods and systems for gamifying a scientific problem are disclosed. A method may include receiving, by a computing device, gameplay information from a first user, creating, by the computing device, a game that corresponds to the gameplay information, providing, by the computing device, the game to a second user, receiving, by the computing device, game information from the second user and translating, by the computing device, the data into scientific information used to solve the scientific problem. The game information may include data regarding the second user's interaction with the game.

### CROSS-REFERENCE TO RELATED APPLICATIONS

This application claims priority to U.S. provisional application Ser. No. 61/678,739, filed Aug. 2, 2012 and entitled, “SYSTEMS AND METHODS OF GAMIFICATION OF A PROBLEM”, which is incorporated herein by reference in its entirety.

### BACKGROUND

Incorporating the individual and collective problem solving skills of non-experts into the scientific discovery process is a useful tool in accelerating the advancement of science. One method of using this tool is achieved by the gamification of a scientific problem. For example, a scientific problem may first be identified, where the collective problem solving potential of non-experts would be useful in solving the scientific problem, and turning the scientific problem into a game, such as by incorporating an engaging gameplay into the problem or making the problem solving fun for non-expert users.

Previous attempts to gamify a scientific problem have resulted in games in which the non-expert players are presented with a game that is very similar to the scientific problem. Thus, the problem may prove to be uninteresting to the non-experts and, as a result, their enthusiasm for the game may wane, thereby reducing the effectiveness of using non-expert problem solvers. Furthermore, previous attempts were not sufficient for an effective large-scale deployment needed to solve complex scientific problems requiring an enormous amount of manpower.

### SUMMARY

In an embodiment, a method of gamifying a scientific problem may include receiving, by a computing device, gameplay information from a first user, creating, by the computing device, a game that corresponds to the gameplay information, providing, by the computing device, the game to a second user, receiving, by the computing device, game information from the second user and translating, by the computing device, the data into scientific information used to solve the scientific problem. The game information may include data regarding the second user's interaction with the game.

In an embodiment, a system for gamifying a scientific problem may include a processing device and a non-transitory, processor-readable storage medium in communication with the processing device. The non-transitory, processor-readable storage medium may contain one or more programming instructions that, when executed, cause the processing device to receive gameplay information from a first user; create a game that corresponds to the gameplay information; provide the game to a second user; receive game information from the second user and translate the data into scientific information used to solve the scientific problem. The game information may include data regarding the second user's interaction with the game.

In an embodiment, a method of solving a scientific problem via gamification may include receiving, by a computing device, gameplay information from an administrator. The gameplay information may correspond to information regarding a scientific problem to be solved. The method may further include creating, by the computing device, a game that corresponds to the gameplay information. The game may be configured to provide information for solving the scientific problem when it is played by a plurality of users. The method may further include providing, by the computing device, the game to a plurality of users and for each of the plurality of users, (i) receiving, by the computing device, game information that includes data regarding the user's interaction with the game and (ii) translating, by the computing device, the data into scientific information. The method may also include aggregating the scientific information from the plurality of users and solving the scientific problem from the aggregated scientific information.

### BRIEF DESCRIPTION OF THE DRAWINGS

FIG. 1 depicts a general schematic representation of an operating environment arranged in accordance with at least some embodiments described herein.

FIG. 2 depicts a block diagram of illustrative internal hardware that may be used to contain or implement programming instructions according to an embodiment.

FIG. 3 depicts a flow diagram of a gameplay process that may be carried out by an electronic device according to an embodiment.

FIG. 4 depicts a flow diagram of a process that may be carried out by a computing device according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “user” is not limited by this disclosure, and may include any user of any of the components and/or elements thereof as described herein. For example, a user can be a researcher, an expert, a player, an administrator, a developer, a group of individuals and/or the like. In some embodiments, the interactions between multiple users may be various users of the same category, such as, for example, multiple players, multiple researchers, multiple experts, multiple administrators, multiple developers, multiple groups and/or the like. In some embodiments, the interactions between multiple users may be various users of differing categories, such as, for example, a player and a researcher, a player and an expert, a player and an administrator and/or the like.

An “electronic device” refers to a device that includes a processor, a tangible, computer-readable memory and a display. The memory may contain programming instructions that, when executed by the processor, cause the device to perform one or more operations according to the programming instructions. Examples of electronic devices may include, but are not limited to, personal computers, gaming systems, televisions, and portable electronic devices such as smartphones, personal digital assistants, cameras, tablet computers, laptop computers, GPS navigation devices, media players, medical devices, telescopes, satellites, recording devices and the like.

A “computing device” is an electronic device, such as a computer, a processor, a memory and/or any other component, device or system that performs one or more operations according to one or more programming instructions.

“Gameplay” refers to a specific way in which users interact with a game. Gameplay can be a pattern defined through one or more game rules, a connection between the user and the game, a challenge presented to the user from the game, a method employed by the user in overcoming the challenges, a plot of the game, turn-by-turn directions in a game, a user's interaction with computer-generated characters and situations, a user's interaction with other users and the user's connection to the game. The gameplay can be interesting, therapeutic, beneficial and engaging to the user, thereby possibly ensuring the user's interaction with the game for extended periods of time, the user providing high-quality inputs (for example, relevant and significant inputs) and also possibly ensuring the user will return to the game multiple times.

A “game” refers to a board game, an electronic game, a gesture-based game, a massively multiplayer online game (MMOG) and/or the like, and may further include any number of activities, exercises and interactions. The game can be created by a software developer, an administrator, or the like, and in some embodiments, creation of the game may be completed by a user based upon the user's interaction with another game. While the present disclosure generally relates to games for entertainment, those skilled in the art may recognize that the scope of the present disclosure may additionally relate to therapeutic, learning and development exercises, medical diagnosis exercises, feedback gathering exercises, proof of human input systems, exercises for assessment and evaluation, interactive advertising, newsfeed gathering and the like. Furthermore, the data collected from activities presented herein may further be used for purposes such as data mining, information retrieval, data organization, data sorting, data indexing, analytic gathering, known problems and scientific problems. In some embodiments, the data may be used for advertising content customization and/or recommendations systems.

A “scientific problem” refers to any problem where the answer is known or not known and experimentation is necessary to obtain an answer or verification of a correct answer. In some embodiments, the answer to the scientific program may not be unique. For example, the answer may be a family of correct, approximately correct, and/or acceptable answers. In some embodiments, the answer may have a probability attached to it, where the probability indicates the correctness and/or accuracy of the answer. Verification can include testing, benchmarking and parameterization of algorithms, methodologies and approaches. While the systems and methods described herein are generally scientific in nature, those skilled in the art will recognize that the systems and methods may be applied to both scientific and non-scientific problems without departing from the scope of the present disclosure.

The present disclosure pertains to methods and systems for presenting an activity interface to one or more users that corresponds to a scientific problem in need of a solution. As will be described in greater detail herein, the activity interface may be in the form of a game, an activity, an exercise, an add-on to a game, a sublevel of a game, a mission pack of a game, and/or the like.

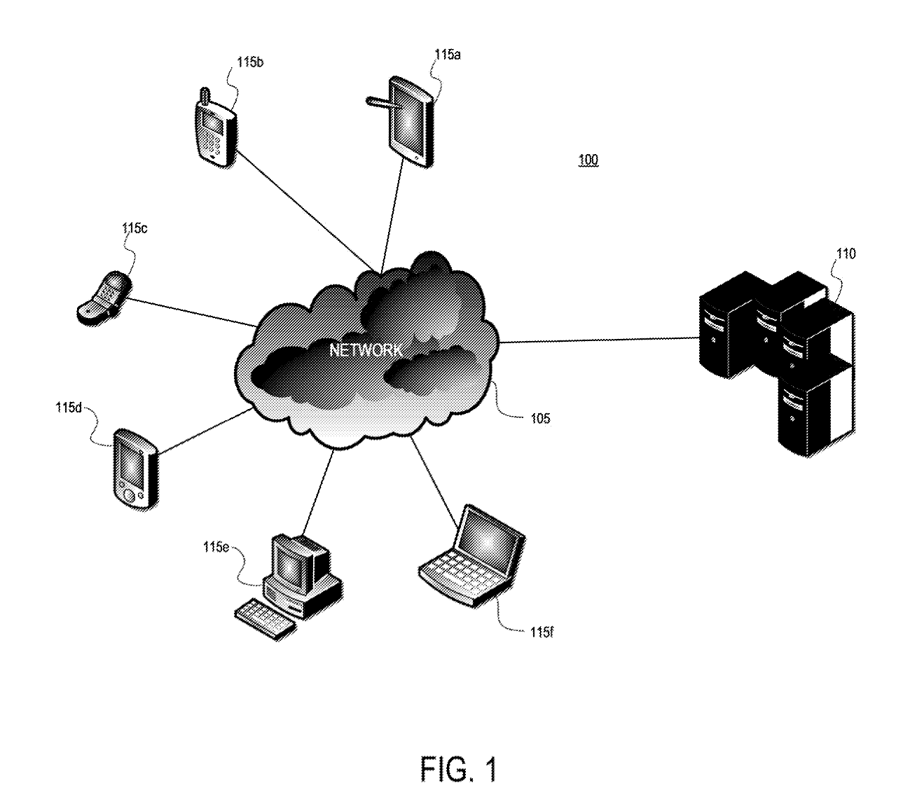

Referring to FIG. 1, a general schematic representation of an operating environment 100 is depicted according to an embodiment. The operating environment 100 may include one or more computing devices 110 and one or more electronic devices 115 configured to communicate with the one or more computing devices via a communications network 105.

Each of the one or more computing devices 110 may be any computing device having a processing device and a storage medium. In embodiments where more than one computing device 110 is used, each computing device may operate independently of the other computing devices, or may operate in an array-type configuration where the computing devices act or function as a single unit. The one or more computing devices 110 may optionally contain one or more databases, as described in greater detail herein. The one or more computing devices 110 may generally provide gameplay applications to one or more of the electronic devices 115, collect data from electronic devices, interact with one or more users and/or solve one or more scientific problems.

The one or more electronic devices 115, such as, for example, a tablet 115a, a smartphone 115b, a feature phone 115c, a PDA 115d, a personal computer 115e and/or a laptop computer 115f, may generally serve as a primary interface with a user, and may further contain one or more applications that request access to encrypted data, as described in greater detail herein. The one or more electronic devices 115 may generally contain programming instructions for interacting with the one or more computing devices 110 and one or more users. The programming instructions may comprise programming for a game, an activity, an exercise and/or the like, such as an application that may be received by the electronic device 115 from a provider, an app store, the one or more computing devices 110 and/or the like. In addition to having an ability to interact with one or more users, each electronic device 115 may further enable each user to interact with another, including users that are interacting with the same electronic device 115 and users that are interacting with different electronic devices 115.

The one or more electronic devices 115 may further communicate with the one or more computing devices 110 via the communications network 105, as described in greater detail herein. The communications network 105 may serve as an information highway interconnecting the other illustrated components. The communications network 105 is not limited by this disclosure, and may include any communications network now known or later developed. The communications network 105 may utilize any suitable data communication, telecommunication, wired communication, wireless communication or other technology. The communications network 105 may be used to connect any number of devices, systems or components, and may further use any number of communications links. For example, the communications network 105 may use one or more of a local area network (LAN), a wide area network (WAN), a wireless local area network (WLAN), a personal area network (PAN), the internet, a cellular network, a paging network, a private branch exchange (PBX) and/or the like. The communications network 105 may further use social networking platforms for connecting users to each other.

The one or more computing devices 110 may be coupled to the communications network 105 via a communications link, such as, for example, a wired link, a wireless link or any combination thereof. Furthermore, each electronic device 115 may be coupled to the communications network 105 via a communications link, such as, for example, a wired link, a wireless link or any combination thereof.

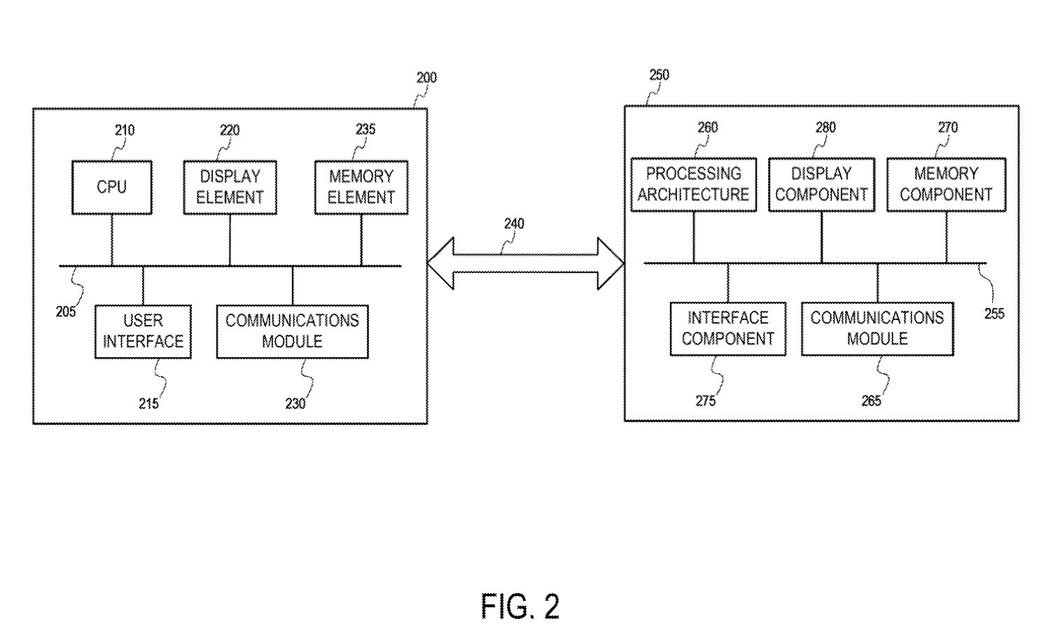

FIG. 2 depicts a schematic representation of communications between an electronic device 200 and one or more computing devices 250, arranged in accordance with at least some embodiments described herein. The electronic device 200 may communicate with the one or more computing devices 250 via a communications link 240, such as, for example, the communications network 105 depicted in FIG. 1.

The electronic device 200 may generally include one or more of a CPU 210, a user interface 215, a display element 220, a communications module 230 and a memory element 235. The modules and/or elements outlined herein are merely examples, and other modules and/or elements may also be included within the electronic device 200 without departing from the scope of the present disclosure. Examples of other modules and/or elements may include, but are not limited to, near field communication (NFC) radios, cellular radios, 802.11 wireless radios, wired data communication interfaces, sensors and/or the like. Examples of sensors may include, for example, pressure sensors, motion sensors, environmental sensors, biological sensors, temperature sensors, pressure sensors, optical sensors, health sensors and/or the like. A bus 205 may serve as an information highway interconnecting the modules and/or elements of the electronic device 200.

The CPU 210 may generally be any processing device that executes one or more operations based on programming instructions stored in the memory element 235. The one or more operations may be completed by the CPU 210, or the CPU 210 may direct other components to complete the operations, as described in greater detail herein.

The CPU 210 may include any number of hardware, software and/or firmware components, as well as any number of logical or functional modules. The CPU 210 may be, for example, a general purpose processing device, a digital signal processor, an application-specific integrated circuit, a field programmable gate array (FPGA), a programmable logic device, a logic gate, and/or combinations thereof. The CPU 210 may further be a microprocessor, a controller, a microcontroller, a state machine or any combination thereof.

The user interface 215 may include, for example, one or more user interface components that may generally be configured to elicit one or more commands to the electronic device 200 when actuated. Examples of user interface components may include keypads, switches, buttons, visual control components, audio control components, haptic control components and/or the like.

The user interface 215 may further include a touch sensitive screen, which may optionally be integrated with the display element 220. The touch sensitive screen may receive contact based inputs from a user, such as from a user's fingers or from a stylus. The touch sensitive screen may be adapted for gesture control, thus allowing for a user to tap, pinch, swipe or provide other similar gestures to elicit commands to the electronic device 200. The touch sensitive screen may further be capable of sending touch commands to the CPU 210. Examples of touch sensitive screens may include, but are not limited to, resistive touchscreens, capacitive touchscreens, infrared touchscreens and/or other technologies now known or later developed. The user interface 215 may also be configured to receive commands via body gestures, voice, audio signals, device movement and/or the like, which may be completed through the use of any number of microphones, speakers, cameras, barometers, gyroscopes and/or the like. The user interface 215 may also be configured to receive inputs from one or more sensors, such as, for example, pressure sensors, motion sensors, environmental sensors, biological sensors, temperature sensors, pressure sensors, optical sensors, health sensors and/or the like.

The display element 220 may generally be used to display images, text, video and the like to a user of the electronic device 200 according to commands received from the CPU 210. Examples of display elements may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The communications module 230 may generally provide an interface between the electronic device 200 and the communications link 240. The communications module 230 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

The memory element 235 may generally be any type of fixed or removable storage device. Examples of memory elements 235 may include, but are not limited to, random access memory (RAM), read only memory (ROM), erasable programmable read only memory (EPROM), electrically erasable programmable read only memory (EEPROM), flash memory, magnetic computer storage devices, optical discs, hard disks, removable disks and the like.

The memory element 235 may generally provide storage for data and/or information, such as program data/information, data/information saved by one or more users, programming instructions and/or the like. The data and/or information contained on the memory element 235 may be used to direct the CPU 210 to carry out one or more commands.

The one or more computing devices 250 may communicate with the electronic device 200 via the communications link 240. The one or more computing devices 250 may have, either individually or collectively, a processing architecture 260, one or more communications modules 265, one or more memory components 270, one or more user interface components 275 and one or more display components 280. The list of components illustrated here is merely an example, and other components of the one or more computing devices 250 may be included without departing from the scope of this disclosure. A bus 255 may serve as the main information highway interconnecting the other illustrated components of the one or more computing devices 250.

The processing architecture 260 may generally support the operation of the one or more computing devices 250, including the data processing schemes described in greater detail herein. The processing architecture 260 may be embodied in any number of hardware, software and/or firmware components, and may include any number of logical or functional modules. The processing architecture 260 may be implemented or performed with a processing device, a content addressable memory, a digital signal processor, an application specific integrated circuit, a field programmable gate array, any programmable logic device, any discrete gate or transistor logic, any discrete hardware components and/or the like. The processing device may be, for example, a microprocessor, a controller, a microcontroller, a state machine or the like. Additionally, or alternatively, the processing device may be implemented as a combination of devices, such as, for example, a digital signal processor and a microprocessor, a plurality of microprocessors, and/or the like.

The one or more communications modules 265 of the one or more computing devices 250 may generally function similar to that of the communications module 230 of the electronic device 200. Thus, the one or more communications modules 265 may generally provide an interface between the one or more computing devices 265 and the communications link 240. The one or more communications modules 265 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

The memory element 270 may generally be any type of fixed or removable storage device. Examples of memory elements 270 may include, but are not limited to, random access memory (RAM), read only memory (ROM), erasable programmable read only memory (EPROM), electric erasable programmable read only memory (EEPROM), flash memory, magnetic computer storage devices, optical discs, hard disks, removable disks and the like.

The memory element 270 may generally provide storage for data and/or information, such as program data/information, data/information saved by one or more users, programming instructions and/or the like.

The user interface 275 may be similar to the user interface 215 of the one or more electronic devices 200. However, where the user interface 215 of the one or more electronic devices 200 may generally be used by a user interacting with the gameplay, as described in greater detail herein, the user interface 275 of the one or more computing devices 250 may generally be used by users conducting research, creating the gameplay, obtaining information and/or the like. The user interface 275 may include, for example, one or more user interface components that may generally be configured to elicit one or more commands to the one or more computing devices 250 when actuated. Examples of user interface components may include keypads, switches, buttons, visual control components, audio control components, pressure control components, haptic control components and/or the like.

The user interface 275 may further include a touch sensitive screen. The touch sensitive screen may receive contact based inputs from a user, such as from a user's fingers. The touch sensitive screen may be adapted for gesture control, thus allowing for a user to tap, pinch, swipe or provide other similar gestures to elicit commands to the one or more computing devices 250. The touch sensitive screen may further be capable of sending touch commands to the processing architecture 260. Examples of touch sensitive screens may include, but are not limited to, resistive touchscreens, capacitive touchscreens, infrared touchscreens and/or other technologies now known or later developed. The user interface 275 may also be configured to receive commands via body gestures, voice, audio signals, device movement and/or the like, which may be completed through the use of microphones, speakers, cameras, barometers, gyroscopes and/or the like. The user interface 275 may also be configured to receive inputs from one or more sensors, such as, for example, pressure sensors, motion sensors, environmental sensors, health sensors and/or the like.

The display element 280 may be similar to the display element 220 of the one or more electronic devices 200, and may generally be used to display images, text, video and the like to a user of the one or more computing devices 250. Examples of display elements may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

Using the system depicted in FIG. 2, a user of the one or more computing devices 250 may input a scientific problem and/or the like to be solved, may gamify the scientific problem to obtain a game, and may provide the game to one or more users via the communications link 240 to be played on their respective electronic devices 200. As a result of playing the game, as described in greater detail herein, the one or more electronic devices 200 may transmit information via the communications link 240 to the one or more computing devices 250 to allow the user and/or the one or more computing devices to solve the scientific problem with the information received, as described in greater detail herein.

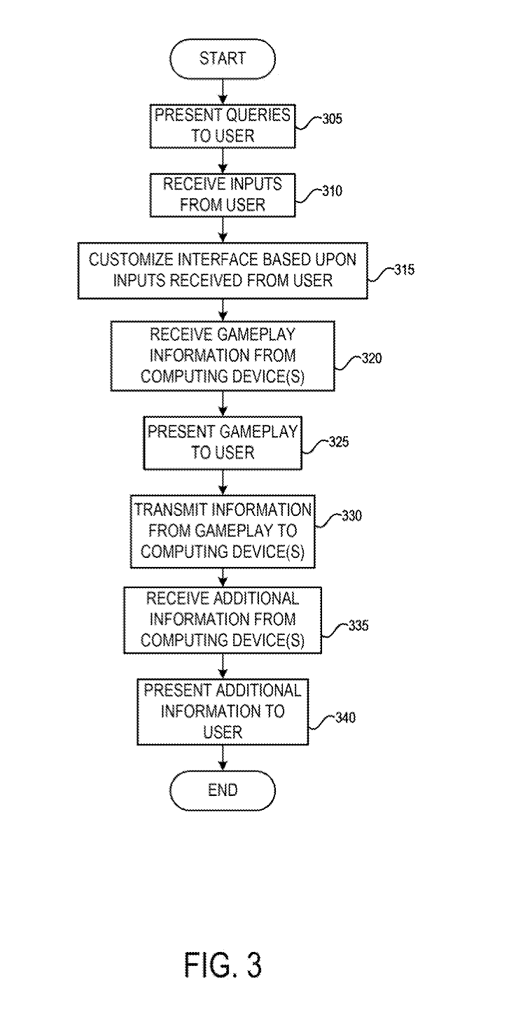

FIG. 3 depicts a flow diagram of a series of commands carried out by the CPU 210 of the electronic device 200 or the processing architecture 260 of the computing device 250 (FIG. 2). The electronic device may present 305 a user or multiple users with one or more queries that may generally be used to set the gameplay settings and customize the desired user interface for each user. Examples of such queries may include, but are not limited to, querying the number of users and/or providing a unique game identifier to allow for additional users to sign in to a game, querying whether computer players/artificial intelligence players are desired, querying the user on the type of game desired, querying the user on the difficulty of game desired, querying the user on whether a two-dimensional or a three-dimensional game is desired, desired topic areas, desired content, color settings, text font, text size, whether audible, visual or haptic feedback is desired, whether background music is desired and/or the like. The electronic device may provide a “randomly select” option to the user, whereby, when selected, the electronic device automatically randomizes and selects responses to one or more of the queries.

If multiple users are participating in the same game, the electronic device may allow for individual customizations in the form of color settings, text font, text size, audible feedback, visual feedback, haptic feedback, background music and/or the like on each electronic device 115 (FIG. 1). In one embodiment, certain gameplay settings may be customized per game and thus each individual user may not be able to set his/her own desired settings. In these instances, the electronic device may designate a single user, such as, for example, the first user to start the new game before others join in, as the user to respond to the queries. Alternatively, the electronic device may present all users with the same query and automatically update the settings across all electronic devices 115 (FIG. 1) whenever a user changes those settings. As another alternative, each user may customize all features, regardless of how another user chooses his/her customization, so as to facilitate crowd-sourced connections and content.

The electronic device may further provide a user with an option to save his/her responses to the queries for future use, and if a user selects this option, the electronic device may automatically store the responses to a file and/or database in the memory and/or a remote storage location (such as, for example, a cloud-based storage service) for future retrieval. When a user selects the option to save his/her responses, the electronic device may, upon subsequent uses, bypass the querying step. As an alternative during subsequent uses, the electronic device may present the querying step with the saved responses to the queries pre-selected, and ask the user if he/she desires to change any of the pre-selected responses.

In various embodiments, the electronic device may also provide a user with queries and/or options to save his/her profile information, which may contain biographical information, user names, passwords, associated accounts, preferred gameplays, favorites and/or the like. In some embodiments, the electronic device may provide a user with queries and/or options to modify or view his/her existing profile information.

All of the queries presented to the user(s) may be optional; if a user desires not to respond to the queries to customize the gameplay and user interface, the electronic device may automatically provide any number of default responses to each of the queries.

The electronic device may customize 315 the interface to match the user's requests and/or the default settings. The customization 315 may include, but is not limited to, generating the gameplay, setting other customizations for each user and the like.

The electronic device may receive 320 gameplay information from the one or more computing devices, and present 325 the gameplay information to each user. The gameplay information may generally provide gameplay that corresponds to scientific problem solving, as described in greater detail in the Examples provided herein. The gameplay, while corresponding to the scientific problem solving, may not be readily apparent as a scientific problem to the user of the electronic device. Rather, the gameplay may appear as an interesting and/or engaging interface with the user. In some embodiments, the user may be unaware that he/she is helping to solve a scientific problem.

In various embodiments, the electronic device may provide one or more incentives to a user in addition to presenting 325 the gameplay to the user. This may generally be completed to provide the user an additional incentive to interact with the game, to ensure a high quality interaction with the game, completion of the entire game and/or the like. In some embodiments, the one or more incentives may be conditional. For example, the incentive may not be provided to the user unless a certain amount of time is spent on a game, unless a certain number of steps have been completed, unless certain data has been provided, unless the game is completed in its entirety and/or the like. Illustrative examples of incentives may include rewards, coupons, gifts, sweepstakes entries and the like. Illustrative examples of rewards may include level-ups, power-ups, badges, and/or the like.

During the progression of the gameplay or after the user is finished playing the game, the electronic device may transmit 330 information to the one or more computing devices. The information may correspond to various interactions, decision making, inputs and/or the like of the user throughout the course of the gameplay. The information may be recognizable by the one or more computing devices as usable to assist in solving a scientific problem, as discussed in greater detail herein.

The electronic device may optionally receive 335 additional information from the one or more computing devices and present 340 the additional information to the user. The additional information is not limited by this disclosure, and may generally be related to the gameplay information transmitted to the one or more computing devices. For example, the gameplay may require the additional information based upon the interaction with one or more users and the responses received from each user in order to proceed with additional gameplay.

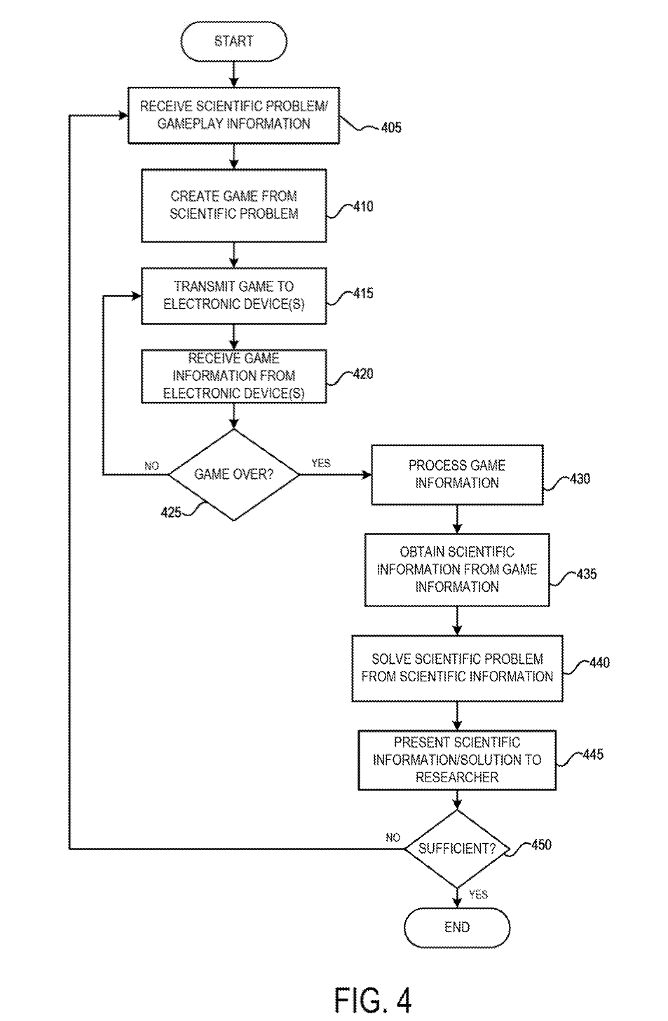

The memory component 270 of the one or more computing devices 250 may direct the processing architecture 260 (FIG. 2) to perform one or more operations. As shown in FIG. 4, the one or more computing devices may receive 405 a scientific problem and/or gameplay information from a user, a researcher, an administrator, a software developer and/or the like. The researcher may generally be one or more of an individual, a group and an entity having a scientific problem to solve. The administrator may generally be one or more of an individual, a group and an entity that controls and/or maintains the one or more computing devices 250. In some embodiments, the researcher may be the same individual, group, or entity as the administrator. The software developer may generally be one or more of an individual, a group and an entity that authors one or more software modules to provide a game, various components of a game, and/or information related to a game, as described in greater detail herein. The gameplay information may be a set of parameters provided to the one or more computing devices that define a problem to be solved, a method of solving a problem, one or more steps necessary to complete a method of solving a problem, a number of users needed to solve a problem, a translation map that provides information for how the game corresponds to the problem to be solved, one or more game scenarios and/or the like. In various embodiments, the one or more computing devices may create 410 a game from the scientific problem and/or the gameplay information. Alternatively, the game may be created by the researcher, an administrator, a software developer and/or the like and provided to the one or more computing devices. In some embodiments, the one or more computing devices may create 410 the game by recreating the scientific problem to be solved in a game format such that at least a portion of the scientific problem is solved via gameplay, as described in greater detail herein. In some embodiments, the one or more computing devices may create 410 the game according to one or more user inputs received in response to queries, as described in greater detail herein.

In various embodiments, the one or more computing devices may optionally transmit 415 the game to the one or more electronic devices to be played by one or more users of each electronic device to help solve the problem. In some embodiments, at least a portion of the game may already be present on the electronic device, and the one or more computing devices may transmit data to the game to initialize the game.

As the gameplay progresses, or at the end of each gameplay session, the one or more computing devices may receive 420 game information from the one or more electronic devices. The game information may generally contain data corresponding to the gameplay and/or a user's interaction with the game. More specifically, the data may correspond to decisions made, actions taken by each user, user inputs and/or the like throughout the course of the game.

After information is received 420, the one or more computing devices may determine 425 whether the game has ended. The game may end due to a user completing the game from start to finish, a user solving all of the problems presented in the game, a user exiting the game and/or the like. In some embodiments, the game may continue in perpetuity and may never end. If the game is not over, the one or more computing devices may continue to provide 415 the game to the one or more electronic devices. If the game is over, the one or more computing devices may process 430 the game information and obtain 435 scientific information from the game information. In some embodiments, the one or more computing devices may provide the game information to one or more researchers, administrators, software developers, users and/or the like for processing and/or obtaining scientific information. Processing may include, for example, retrieving data, translating data, transmitting data and/or the like that was generated based upon gameplay. Furthermore, obtaining scientific information may include translating the information that was processed into information that may be used to solve the scientific problem.

Armed with the scientific information obtained 435 in the previous step, the one or more computing devices may solve 440 the scientific problem and present 445 the solution to the one or more researchers, the one or more administrators, the one or more software developers and/or the like. Alternatively, the one or more computing devices may present 445 the scientific information to the one or more researchers, the one or more administrators, the one or more software developers and/or the like for analysis or solving.

In various embodiments, the one or more computing devices may determine 450 whether the information presented 445 to the one or more researchers, the one or more administrators, the one or more software developers and/or the like is sufficient for analysis or solving. This determining 450 may be completed by any means of determining sufficiency of data, such as, for example, analysis of the information via an algorithm, receiving various inputs from users that the information is sufficient or insufficient and/or the like. If the information is not sufficient, the process may repeat in its entirety. In some embodiments, the process may repeat with a different game, a different game format, different parameters and/or the like.

The scientific problem may generally be solved by use of any method of solving problems, and is not limited by this disclosure. For example, the scientific problem may be solved through the use of crowd sourcing, such as, for example, having a plurality of users answer the same question multiple times under varying scenarios, and then using analytics to determine which answer of all of the possible answers is correct. The analytics may determine, for example, that the most common answer is the correct answer. The number of users is not limited by this disclosure and may contain any number of users. For example, in some embodiments, the crowd sourced solving may include a large number of users. Specific examples of the number of users may be from about 1 user to about 10 million users or more. In some embodiments, the crowd sourced solving may include about 1 user, about 10 users, about 50 users, about 100 users, about 500 users, about 1000 users, about 5000 users, about 1000 users, about 5000 users, about 10,000 users, about 50,000 users, about 100,000 users, about 500,000 users, about 1 million users, about 5 million users, about 10 million users or any value or range between any two of these values.

The above disclosed methods may include any type of gameplay. Some illustrative examples of specific gameplay scenarios are provided in the following examples.

### EXAMPLE 1

The number of cells present in a cell culture at a given time is an important parameter in many biological studies. One such example is the quantification of cell proliferation under various conditions, such as growth hormones or drugs. Such studies may have implications in many fields, such as, for example, cancer research, tissue repair and stem cell differentiation. While flow cytometry may be used for counting a large number of cells in suspension, microscopy is widely used to quantify adherent cells that are in smaller populations.

In a typical experiment, researchers stain the nuclei and count the cells manually, either by viewing through a microscope or by viewing micrographs. Human vision is able to discern any ambiguities that may not be discernible by electronic methods for cell counting, such as, for example, software applications. However, a large amount of data is produced in each experiment, thus making the task of manual cell counting very tedious.

As a solution, the task of counting cells on a micrograph is transformed into a “shooting game” in which the original image is divided into smaller units. The smaller units provide privacy protection and may require less computing power. Furthermore, the “shooting game” transforms the stained nucleus into a target that does not resemble a cellular nucleus, but rather is something that is more interesting and engaging, such as, for example, targets, antagonistic characters and/or the like. The background is also transformed into a terrain or a backdrop that sets the theme of the game. First, the image is split into several pieces. The image is divided into a plurality of smaller images by the researchers and/or the one or more computing devices, or is optionally gamified so that a non-expert completes the dividing, such as a game where the non-expert is required to slice objects into pieces. The objects are something that is interesting and appealing and is transformed from the images.

Once the image has been split and the cells have been counted, it may be necessary to put the divided smaller images back into one single image. This is accomplished through the use of a “jigsaw puzzle”-type game. In this type of game, a user may be tasked with discovering an interlocking manner of a plurality of objects and arranging the objects in the proper sequence. In an alternative method of putting the smaller images back into one single image, each smaller image corresponds to a specific pattern, and a user is tasked with matching identical patterns together. Information that is retrieved from the placement and/or matching games provides a high level of matching. For example, a piece with “6 cells” will be different from one with “5 cells,” even in instances where the actual number of cells is unknown, because a statistically large population of users would have matched the images in a similar manner. This information is combined with results from other games that are transformed from the same set of images.

The above transformations can also be applied to similar set of problems such as, for example, detecting different cell types based on different colors and localization of proteins in cells or tissues.

Another method of having users outline cells may present a game as a “minefield in a shadow-realm.” First, the game is transformed into an “alien kingdom” rather than a cell image. Gameplay is generally a simple “swipe” game where, with a single finger swipe, the user identifies any areas where there are no cells. The empty areas are also embellished with gaming graphics and the areas with cells are applied with image processing techniques so that they blend in with the background. Once users play this transformed game landscape, consensus voting techniques are employed to determine more accurate tracings of cells. This is delivered to a software program capable of coloring all of the cells based on the traces. Thus, regions would be identified with cells and the cells would be transformed into dots/targets/discs for the gameplay.

Another method for counting cells includes a familiar game where users are equipped with a “gun” to tag targets, which are presented as static objects in a terrain or as dynamic objects (i.e., the images move on the screen). By tagging the objects, the user is unknowingly contributing to counting the cells from an image. At first glance, this step may appear to be redundant since the cells could have been counted as described above. However, this method is distinct for at least two reasons: (1) the outlining step is a drawing technique rather than a counting technique; thus a discrete counting step is still necessary to obtain a count (e.g., disc shooting); and (2) in a coloring phase, coloring may be completed based upon a score, e.g., the areas that were outlined by a large number of users will be colored with a high intensity, whereas the areas that were outlined by a lower number of users will be colored with a low intensity. Rather than requiring a computer to make a judgment (which would be based upon arbitrary thresholds), the users in the shooting round would be used to determine whether discs are valid. In this instance, a counter records the number of targets tagged by the user. As multiple scores are reported from various users, a statistical algorithm is used to rate the performance and provide an appropriate score.

An immediate question that arises is a question of whether the gamification scenarios presented in the examples above are statistically valid. This is a cogent point, particularly because the problem(s) being solved have no standards with which to measure the results. Methods of resolving this issue may include:

(1) Use of a focus group to test the examples and verify the results achieved. Additional virtual users may be simulated using focus group results to arrive at a statistically large sample. Furthermore, experts may be tasked with reviewing a set of images ranging in quality from high resolution clear images to poor quality images. This method may provide expectations of accuracy.

(2) Use of a game in an iterative manner, or by adding different transformations to further gamify the problem. For example, instead of creating a shooting game, a “splash in the puddles” game may be used with the same set of images as the shooting game. As a result, information about the original image is collected in multiple different ways through the use of multiple gameplay systems, and may be further collected multiple times, thereby ensuring accuracy of data collection.

(3) A component of each game may be collaborative; thus, a portion of the game may involve requiring or requesting users to vote on other users' results. This may be deployed at multiple levels. For example, in online help forums, users may collaborate on providing solutions, whereby proposed solutions are rated by others. Another example may include gamifying the voting process, such as by use of a shooting game wherein the voting is presented as multiple users shooting the same image. The images with the lowest scores may be filtered out or transferred to another game and then a second round of voting begins again until a consensus is determined based upon the best users. Each time a new round of voting is conducted, the original images may be divided and rejoined so each user has a different view of the game.

### EXAMPLE 2

Tracing neurons from images is an important yet time-consuming analysis in the field of neuroscience. However, traced neurons can provide scientists and doctors with a greater understanding of neuronal structure and function. Although there are automated image analysis programs that attempt to trace neurons from images, the most effective method remains a manual tracing or verification method, particularly because human ability for pattern recognition has not been surpassed by computation methods.

An example of neuron tracing involves one or more researchers. The one or more researchers collect images such as micrographs and use an automated method of verification and/or a manual method of verification to trace each neuron. This method of neuron mapping for the mapping of a simple organ, such as, for example, a human eye, can take up to 6 months to complete.

The task of tracing and mapping neurons are transformed and gamified at multiple layers. One method includes dividing the original image into smaller units as a way to provide privacy protection and to make it easier to handle the graphics, similar to Example 1 herein. The stained axons are transformed into a “lighted path” that resemble lightning, a pathway or a rope. The transformation is achieved by using algorithms and/or crowd sourcing users to determine the paths through a game. The background is transformed into a terrain or a backdrop that sets the theme of the game. The users are engaged in a game where they are asked to follow and/or clear a pathway based on clues that are provided to them. Role players, such as, for example, verifiers and experts, are part of the crowd and their input is given a greater weight during statistical analysis. Verification itself is also gamified, such as, for example, spotting differences between a pair of images. As a result, the image is treated as a map and the goal to identify relevant paths may include the outlines traced by users.

During the tracing process, users meet each other on the map, tag each other and move on. These acts count towards a series of points and/or rewards that are based upon the tracing and tagging. Users are also tasked with connecting a bridge between two spots on a map, and the most frequently used path for tracing the bridge is used to approximate the actual neuron trace.

Other variations include using bright spots on the image, which are identified by a small group of experts or other users, to serve as “lighthouses” on the map that all users must pass through during the tracing process. Users that find hard-to-locate spots earn extra points and/or incentives for finding. Another method involves a social networking aspect, where tracing and tagging is shared with social networking connections to encourage them to join in as a user.

### EXAMPLE 3

The set of games disclosed in this example have broad applications in economics, science, marketing and the like because the games may be generally based on game-theory principles. Allocating resources for projects or products based on community or customer feedback is important in making business decisions. For example, a large company that makes and/or sells a plurality of different consumer products is interested in determining how it should be allocating its resources for different consumer products. The company will further enjoy customer feedback without revealing the true identity of the products.

This transformation is achieved through the use of metaphors. The transformation, which is essentially a customer analytics problem, is gamified into a familiar game, such as, for example, “rock-paper-scissors” where a plurality of elements (e.g., three elements) are associated within a circular win-loss situation. In the circular win-loss situation, a first element defeats a second element, but is defeated by a third element. Furthermore, the second element defeats the third element.

Analytics that transform the association of each product with an element are also used to transform each element to a particular consumer. For example, the three products are a caffeine drink, a thirst-quencher and a health drink. Each drink is respectively transformed into a traditional rock-paper-scissors game where each user has only one element. For example, a “rock” person is someone who is stubborn in the view points and analytics might show that such a person drinks a lot of caffeine drinks, a “paper” person chooses to drink more health drinks, and a “scissors” person chooses to drink more thirst-quenchers. By recording user sessions, researchers are able to discern the relative importance of products and the demographics that favor one product over another product.

A user's preference for a certain drink is discerned, for example, by offering rewards, coupons, discounts and/or the like for particular drinks The user's preference can be determined by observing which reward, coupon, discount and/or the like the user chooses more often. This observation is further compared with any preferred game choices selected by each user.

This can also be used in economics applications where resources may be mapped to the gaming components. By allowing a large number of users to participate in the game, analytics on the user's choice, especially when faced with limited resource, provides an understanding on how best to allocate the resource.

### EXAMPLE 4

A scientific problem involving the docking of macromolecules is gamified. This is accomplished, for example, by having users attempt to fit two 3D shaped objects together, such as two 3D puzzle shapes or the like. A similar gamification scenario is used for pharmaceutical screening of targets and compounds.

### EXAMPLE 5

A scientific problem involving protein folding is gamified by simulating a game, such as, for example, a space based game where users are given an ability to control space ships, space stations and/or the like. Each space ship, space station and/or the like is analogous to or corresponds with particular atoms and/or molecules. Specific forces between molecules and/or atoms are modeled as, for example no fly zones, gravitational forces and/or the like so that the constraints of a 3D structure of each atom and/or molecule can be included.

### EXAMPLE 6

A scientific problem involving optimization is also gamified. Optimization includes requiring a user to find the shortest path in a maze, the shortest path through a set of obstacles and/or the like. Every time the user is able to beat his or her record or the record of another user, they receive a reward, such as bonus points, unlocked levels and/or the like. This optimization is used for any number of scientific and/or non-scientific problems, including, for example, scheduling algorithms, resources optimization and/or the like.

### EXAMPLE 7

A scientific problem involving matching is also gamified. This includes, for example, finding trademarked icons, images, photographs, videos and/or the like. The gamification is, for example, a memory game or a game where a user is required to find similar images where the image of interest is matched to scrolling image dataset of existing trademarked images. Another method involves duplicating a target image and existing images and requires a user to pick all similar image sets in a deck of images. Other gamification options further include tagging images, videos, photographs and/or the like, recognizing handwriting and crowd sourced map construction.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of gamifying a scientific problem, the method comprising:
receiving, by a computing device, gameplay information from a first user;
creating, by the computing device, a game that corresponds to the gameplay information;
providing, by the computing device, the game to a second user;
receiving, by the computing device, game information from the second user, wherein the game information comprises data regarding the second user's interaction with the game; and
translating, by the computing device, the data into scientific information used to solve the scientific problem.

2. The method of claim 1, wherein receiving the gameplay information further comprises receiving, by the processing device, the scientific problem.

3. The method of claim 1, wherein creating the game further comprises recreating, by the processing device, the scientific problem in a game format such that at least a portion of the scientific problem is solved via gameplay of the game.

4. The method of claim 1, wherein creating the game further comprises creating, by the processing device, the game according to one or more user responses to queries regarding gameplay settings and user customizations.

5. The method of claim 1, wherein the gameplay information comprises one or more of the following: a set of parameters that define a problem to be solved, a method of solving a problem, one or more steps necessary to complete a method of solving a problem, a number of users needed to solve a problem, a translation map, and one or more game scenarios.

6. The method of claim 1, wherein the game information further comprises data corresponding to one or more of the following: decisions made by the second user, actions taken by the second user, and inputs provided by the second user.

7. The method of claim 1, further comprising providing, by the computing device, the scientific information to the first user.

8. The method of claim 1, further comprising providing, by the computing device, an incentive to the second user.

9. A system for gamifying a scientific problem, the system comprising:
a processing device; and
a non-transitory, processor-readable storage medium in communication with the processing device, wherein the non-transitory, processor-readable storage medium contains one or more programming instructions that, when executed, cause the processing device to:
receive gameplay information from a first user;
create a game that corresponds to the gameplay information;
provide the game to a second user;
receive game information from the second user, wherein the game information comprises data regarding the second user's interaction with the game; and
translate the data into scientific information used to solve the scientific problem.

10. The system of claim 9, wherein the one or more programming instructions that, when executed, cause the processing device to receive the gameplay information further comprises one or more programming instructions that, when executed, cause the processing device to receive the scientific problem.

11. The system of claim 9, wherein the one or more programming instructions that, when executed, cause the processing device to create the game further comprises one or more programming instructions that, when executed, cause the processing device to recreate the scientific problem in a game format such that at least a portion of the scientific problem is solved via gameplay of the game.

12. The system of claim 9, wherein the one or more programming instructions that, when executed, cause the processing device to create the game further comprises one or more programming instructions that, when executed, cause the processing device to create the game according to one or more user responses to queries regarding gameplay settings and user customizations.

13. The system of claim 9, wherein the gameplay information comprises one or more of the following: a set of parameters that define a problem to be solved, a method of solving a problem, one or more steps necessary to complete a method of solving a problem, a number of users needed to solve a problem, a translation map, and one or more game scenarios.

14. The system of claim 9, wherein the game information further comprises data corresponding to one or more of the following: decisions made by the second user, actions taken by the second user, and inputs provided by the second user.

15. The system of claim 9, further comprising one or more programming instructions that, when executed, cause the computing device to provide the scientific information to the first user.

16. A method of solving a scientific problem via gamification, the method comprising:
receiving, by a computing device, gameplay information from an administrator, wherein the gameplay information corresponds to information regarding a scientific problem to be solved;
creating, by the computing device, a game that corresponds to the gameplay information, wherein the game is configured to provide information for solving the scientific problem when it is played by a plurality of users;
providing, by the computing device, the game to a plurality of users;
for each of the plurality of users:
receiving, by the computing device, game information comprising data regarding the user's interaction with the game, and
translating, by the computing device, the data into scientific information;
aggregating the scientific information from the plurality of users; and
solving the scientific problem from the aggregated scientific information.

17. The method of claim 16, wherein creating the game further comprises creating, by the processing device, the game according to one or more user responses to queries regarding gameplay settings and user customizations.

18. The method of claim 16, wherein the gameplay information comprises one or more of the following: a set of parameters that define a problem to be solved, a method of solving a problem, one or more steps necessary to complete a method of solving a problem, a number of users needed to solve a problem, a translation map, and one or more game scenarios.

19. The method of claim 16, wherein the game information further comprises data corresponding to one or more of the following: decisions made by each of the users, actions taken by each of the users, and inputs provided by each of the users.

20. The method of claim 16, further comprising providing, by the computing device, the scientific information to the administrator.
